(19) United States
(12) Patent Application Publication
(10) Pub. No.: US 2026/0250523 A1
(43) Pub. Date: Aug. 27, 2026

(54) Acid Resistant Conductive Paste Composition

(71) Applicant: Celanese Mercury Holdings Inc., Wilmington, DE (US)

(72) Inventor: Paul VerNooy, Hockessin, DE (US)

(21) Appl. No.: 19/465,992

(22) Filed: Jan. 30, 2026

Related U.S. Application Data
(60) Provisional application No. 63/761,283, filed on Feb. 21, 2025.

(51) Int. Cl. C09D 5/24; C04B 41/46; C04B 41/50; C04B 41/83; C04B 41/88; C09D 7/61

(52) U.S. Cl. CPC C09D 5/24; C04B 41/463; C04B 41/5023; C04B 41/83; C04B 41/88; C09D 7/61

(57) ABSTRACT

The present disclosure is directed to a conductive paste composition. The conductive paste composition may be acid resistant. The conductive paste composition may be particularly suitable for plating applications, such as plating applications involving acidic solutions. The methods of the present disclosure are directed to making the aforementioned conductive paste composition and for making an article including a ceramic substrate and a fired conductive paste composition.

### RELATED APPLICATIONS

The present application is based upon and claims priority to U.S. Provisional Patent Application Ser. No. 63/761,283, having a filing date of Feb. 21, 2025, which is incorporated herein by reference in its entirety.

### BACKGROUND OF THE INVENTION

Generally, a conductive paste composition may contain a conductive component (e.g., a metal), a binder (e.g., a frit), an organic medium, and other optional additives. For the conductive component, powders of the noble metals palladium (Pd), platinum (Pt), gold (Au), silver (Ag), or mixtures or alloys thereof, or oxides of palladium and silver, or mixtures thereof, have been used. Copper powder is a less-expensive option, but is typically calcined under an inert atmosphere.

In general, after a conductive paste composition is applied to a substrate, the conductive paste composition is fired in a furnace to sinter the metallic particles of the conductive paste composition to form a fired conductive paste composition. After the metallic particles are sintered and fused together, the substrate may be cooled. After the cooling of the substrate, various metals may be applied to the fired conductive paste composition to improve various properties of the combined composition of the substrate and the fired conductive paste composition. Notably, the application of a metal to a fired conductive paste composition may involve a plating process, which may use acidic solutions for a number of reasons, including maintaining the solubility of metal salts or ions in solution. However, the contact of an acidic solution with the fired conductive paste composition may result in the dissociation or delamination of the fired conductive paste composition from the substrate.

As a result, there is a need to provide an improved conductive paste composition that is acid resistant.

### SUMMARY OF THE INVENTION

Aspects and advantages of the disclosure will be set forth in part in the following description, or may be obvious from the description, or may be learned through practice of the present disclosure.

In accordance with one embodiment of the present disclosure, provided is a conductive paste composition including a metallic powder, a borosilicate glass frit, a ruthenium-based powder, and an organic medium. The borosilicate glass frit includes SiO₂, B₂O₃, and WO₃. The organic medium includes a solvent and a polymer or resin.

In some implementations, the metallic powder comprises a copper powder.

In some implementations, the metallic powder is present in the conductive paste composition in an amount of about 50 wt. % to about 95 wt. %.

In some implementations, the conductive paste composition further comprises copper oxide, the copper oxide being present in the conductive paste composition from about 0.1 wt. % to about 15 wt. %.

In some implementations, the glass frit is present in the conductive paste composition in an amount from about 0.5 wt. % to about 10 wt. %.

In some implementations, the glass frit comprises WO₃ in an amount from about 5 wt. % to about 30 wt. %, based on the total weight of the glass frit.

In some implementations, the glass frit comprises WO₃ in an amount from about 8 wt. % to about 20 wt. %, based on the total weight of the glass frit.

In some implementations, the glass frit further comprises CaO in an amount from about 5 wt. % to about 35 wt. %, based on the total weight of the glass frit.

In some implementations, the glass frit further comprises CaO in an amount from about 12 wt. % to about 30 wt. %, based on the total weight of the glass frit.

In some implementations, the ruthenium-based powder is ruthenium oxide, the ruthenium oxide being present in the conductive paste composition in an amount from about 0.5 wt. % to about 5 wt. %.

In some implementations, the organic medium is present in the conductive paste composition in an amount from about 3 wt. % to about 20 wt. %.

In some implementations, the glass frit is substantially free of zinc oxide.

In some implementations, the glass frit is substantially free of strontium oxide.

In some implementations, the glass frit is substantially free of barium oxide.

In accordance with another embodiment of the present disclosure, provided is an article. The article includes a ceramic substrate and a fired conductive paste composition. The fired conductive paste composition is formed from a conductive paste composition. The conductive paste composition includes a metallic powder, a borosilicate glass frit, a ruthenium-based powder, and an organic medium. The borosilicate glass frit includes SiO₂, B₂O₃, and WO₃. The organic medium includes a solvent and a polymer or resin.

In some implementations, the ceramic substrate comprises aluminum nitride.

In some implementations, the glass frit is present in the conductive paste composition in an amount from about 0.5 wt. % to about 10 wt. %.

In some implementations, the glass frit comprises WO₃ in an amount from about 8 wt. % to about 20 wt. % based on the total weight of the glass frit, wherein the glass frit further comprises CaO, wherein the glass frit comprises CaO in an amount from about 12 wt. % to about 30 wt. % based on the total weight of the glass frit.

In accordance with another embodiment of the present disclosure, provided is a method for forming an article. The method includes applying a conductive paste composition to a ceramic substrate and firing the conductive paste composition such that the conductive paste composition forms a fired conductive paste composition on the ceramic substrate. The conductive paste composition includes a metallic powder, a borosilicate glass frit, a ruthenium-based powder, and an organic medium. The borosilicate glass frit includes SiO₂, B₂O₃, and WO₃. The organic medium includes a solvent and a polymer or resin.

In some implementations, the glass frit comprises WO₃ in an amount from about 8 wt. % to about 20 wt. %.

### BRIEF DESCRIPTION OF THE FIGURES

A full and enabling disclosure of the present disclosure, including the best mode thereof, directed to one of ordinary skill in the art, is set forth more particularly in the remainder of the specification, which makes reference to the appended figures in which:

FIG. 1 is a cross sectional view of an article according to one embodiment of the present disclosure;

FIG. 2 is a cross sectional view of an article according to one embodiment of the present disclosure; and

FIG. 3 is a flow chart of an example method of forming an article according to one embodiment of the present disclosure.

Repeat use of reference characters in the present specification and drawing is intended to represent the same or analogous features or elements of the disclosure.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to an acid resistant conductive paste composition and a method of forming and using said conductive paste composition. Further, the present disclosure is directed to an article including a fired conductive paste composition, a ceramic substrate (e.g., aluminum nitride), and optionally a metal layer. The conductive paste composition may include one or more metallic powders, a glass frit, a ruthenium-based powder, an organic medium, and other optional additives. The present inventors have discovered that the conductive paste composition of the present disclosure is acid resistant. Namely, the present inventors have discovered that the use of tungsten oxide and cations generally having lower basicity in the glass frit of a conductive paste composition may enhance the acid resistance of a fired conductive paste composition. Further, the present inventors have discovered that the use of ruthenium oxide in a conductive paste composition may result in the enhanced acid resistance of the fired conductive paste composition as compared to a fired conductive paste composition containing lithium ruthenate.

It should be understood that the conductive paste composition of the present disclosure is generally applicable for use in the electronics industry, the automotive industry, and/or the glass and ceramics industry. Notably, the conductive paste composition may be used for the production of a conductor on aluminum nitride, aluminum oxide (alumina), silicon nitride, and other ceramic substrates. Generally, the fired conductive paste composition has excellent adhesion to a substrate.

It should be understood that throughout the entirety of this disclosure, each numerical value (e.g., weight percentage, mole percentage) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

It should be understood that, unless stated otherwise, any standard listed herein (e.g., ASTM) is the most recent version available as of the latest revision year. Notably, some aspects of the present disclosure may omit one or more of the features disclosed herein.

### I. Conductive Paste Composition

a. Metallic Powder

As previously disclosed herein, a conductive paste composition formed in accordance with the present disclosure may include one or more metallic powders. Notably, the one or more metallic powders may include aluminum, copper, gold, nickel, palladium, platinum, silver, or a combination or alloy thereof.

A metallic powder in accordance with the present disclosure may include one or more core-shell particles. Notably, the core or shell of a core-shell particle may be formed from aluminum, copper, gold, nickel, palladium, platinum, silver, or a combination or alloy thereof. In some aspects, the metallic powder may be wholly or partially coated. In this respect, in some aspects, the metallic powder may be wholly or partially coated by organic materials and/or may be metallic powder wholly or partially coated by the oxidized form of a metal. For instance, a copper particle may be wholly or partially coated by oxidized copper. Notably, the oxidized metal may be any of the metals disclosed herein (e.g., copper) or a combination or alloy thereof.

In some aspects, the metallic powder may be present in the conductive paste composition in an amount from about 30 wt. % to about 95 wt. %, including all increments of 1 wt. % therebetween. For instance, the metallic powder may be present in the conductive paste composition in an amount from about 50 wt. % to about 90 wt. %, such as from about 60 wt. % to about 90 wt. %, such as from about 70 wt. % to about 85 wt. %.

In general, a metallic powder formed in accordance with the present disclosure may include from about 90 wt. % to about 100 wt. % of an elemental metal (e.g., copper), including all increments of 0.01 wt. % therebetween. For instance, the metallic powder may include an elemental metal in an amount from about 92 wt. % to about 100 wt. %, such as from about 95 wt. % to about 100 wt. %, such as from about 98 wt. % to about 100 wt. %.

Generally, the particles of the metallic powder may have any shape or morphology. For instance, the particles of the metallic powder may have a shape or morphology such that the particles have a flake form, a spherical form, a rod form, a granular form, a nodular form, a layered or coated form, other irregular forms, or a combination thereof.

In some aspects, the metallic powder may be a copper powder. Notably, a copper powder may include copper oxide. Copper oxide may improve the adhesion of a fired conductive paste composition on ceramic substrates (e.g., aluminum nitride substrates), so when considering the copper oxide content of a conductive paste composition, it is important to note the contribution from the copper oxide of the copper powder.

In some aspects, the conductive paste composition may include copper oxide, such as Cu₂O and/or CuO, in an amount from about 0.001 wt. % to about 20 wt. %, including all increments of 1 wt. % therebetween. For instance, the conductive paste composition may include copper oxide, such as Cu₂O and/or CuO, in an amount from about 0.1 wt. % to about 15 wt. %, such as from about 1 wt. % to about 12 wt. %, such as from about 2 wt. % to about 10 wt. %. In some aspects, the copper oxide may be a milled copper oxide.

In general, the copper powder may have a D₅₀ particle size of from about 0.01 μm to about 10 μm, including all increments of 0.01 μm therebetween. For instance, a copper powder may have a D₅₀ particle size from about 0.01 μm to about 5 μm, such as from about 0.1 μm to about 4 μm, such as from about 0.5 μm to about 3 μm. Notably, the D₅₀ particle size of a copper powder may be measured by laser diffraction according to the method ASTM B822-20, using water as the suspending medium and calculations based on MIE theory.

Notably, if the particle size of the copper powder is too small, cracks may be prone to occur due to sintering occurring too rapidly during the firing process. Further, depending on the severity of the cracking, the fired conductive paste composition may peel off and/or the conductivity of the fired conductive paste composition may be substantially decreased. Notably, if the particle size of the copper powder is too large, sintering may not occur to a sufficient degree for the fired conductive paste composition layer to attain adequate conductivity and/or the fired conductive paste composition may develop internal voids to an extent that the voids interfere with the fired conductive paste composition's conductivity.

In some aspects, the specific surface area of a copper powder may be from about 0.1 m²/g to about 8.0 m²/g, including all increments of 0.1 m²/g therebetween. For instance, the specific surface area of a copper powder may be from about 0.2 m²/g to about 6 m²/g, such as from about 0.3 m²/g to about 5 m²/g, such as from about 0.5 m²/g to about 3 m²/g. The specific surface area may be measured by a BET method, such as ASTM B922-22, with a device such as Monosorb™ from Quantachrome Instruments Corporation.

b. Glass Frit

As previously disclosed herein, a conductive paste composition formed in accordance with the present disclosure may include a glass frit.

The glass frit may be an amorphous (non-crystalline) solid material. However, in some aspects, the glass frit may be amorphous, partially amorphous, partially crystalline, or a combination thereof. It should be understood that the term “glass frit” includes all such compositions. The glass frit may be a borosilicate glass frit, such as an alkali alumino-borosilicate, an alkaline-earth zinc-alumino-borosilicate, or an alkali/alkaline-earth zinc alumino-borosilicate. Generally, the glass frit may enhance the adhesion of a fired conductive paste composition to a ceramic substrate. Further, a glass frit may enhance the chemical resistance of a fired conductive paste composition. The utilization of a glass frit in accordance with the present disclosure may increase the resistance of a fired conductive paste composition to one or more acids.

Notably, the weight percentages and/or mole percentages of the glass frit are the weight percentages and/or mole percentages of the components used in the starting material that may be subsequently processed as described herein. Such nomenclature is conventional to one of skill in the art. In other words, the composition contains certain components, and the weight percentages and/or mole percentages of those components are expressed as a weight percentage and/or mole percentage of the corresponding oxide form. The components of the glass composition may be supplied by various sources, such as oxides, halides, carbonates, nitrates, phosphates, hydroxides, peroxides, halogen compounds, and mixtures thereof. Herein, the composition of the glass frit is given in terms of the equivalent oxides no matter the source of the various components. As recognized by one of ordinary skill in the art in glass chemistry, a certain portion of volatile species may be released during the process of making the glass. An example of a volatile species is carbon dioxide.

A glass frit may be prepared by initially mixing the components of the glass frit (e.g., one or more metal oxides). The preparation of the glass frit may include heating the mixture in air or an oxygen-containing atmosphere to form a melt, quenching the melt, and grinding, milling, and/or screening the quenched material to provide a powder with the desired particle size. Notably, the melting of the mixture is typically conducted to a peak temperature of from about 1000° C. to about 1600° C., including all increments of 1° C. therebetween. The molten mixture may be quenched, for example, on a stainless steel platen, between counter-rotating stainless steel rollers to form a platelet, or in water. The resulting platelets or granules may be milled to form a powder. Notably, a glass frit may be prepared by methods such as, for example, the methods described in U.S. Pat. No. 5,439,852, which is incorporated herein by reference in its entirety.

A glass frit may include one or more oxides, one or more halides, one or more carbonates, one or more nitrates, one or more phosphates, one or more hydroxides, one or more peroxides, one or more halogen compounds, or a combination thereof. In some aspects, the glass frit may include one or more metal oxides. For instance, a glass frit may include aluminum oxides (e.g., Al₂O₃), boron oxides (e.g., B₂O₃), calcium oxides (e.g., CaO), copper oxides (e.g., CuO, Cu₂O), lithium oxides (e.g., Li₂O), manganese oxides (e.g., MnO₂), silicon oxides (e.g., SiO₂), sodium oxides (e.g., Na₂O), tungsten oxides (e.g., WO₃), zirconium oxides (e.g., ZrO₂), or a combination thereof. A glass frit formed in accordance with the present disclosure may be substantially free of zinc oxides (e.g., ZnO), barium oxides (e.g., BaO), bismuth oxides (e.g., Bi₂O₃), strontium oxides (e.g., SrO), or a combination thereof. As used herein, a glass frit “substantially free” of zinc oxides, barium oxides, bismuth oxides, or strontium oxides refers to a glass frit having a zinc oxides content, a barium oxides content, a bismuth oxides content, or a strontium oxides content of about 1 wt. % or less, such as about 0.5 wt. % or less, such as about 0.1 wt. % or less, such as about 0.01 wt. % or less, such as about 0.001 wt. % or less respectively. Notably, the inclusion of zinc oxides, which includes a basic cation, in a glass frit used to form a conductive paste composition may result in a fired conductive paste composition having decreased resistance to one or more acids. It should be understood that the conductive paste composition may be substantially free of zinc oxides, barium oxides, bismuth oxides, strontium oxides, or a combination thereof. As used herein, a conductive paste composition “substantially free” of zinc oxides, barium oxides, bismuth oxides, or strontium oxides refers to a conductive paste composition having a zinc oxides content, a barium oxides content, a bismuth oxides content, or a strontium oxides content of about 1 wt. % or less, such as about 0.5 wt. % or less, such as about 0.1 wt. % or less, such as about 0.01 wt. %, such as about 0.001 wt. % or less respectively.

As previously disclosed herein, the conductive paste composition disclosed herein may have enhanced acid resistance. Generally, it may be preferable to decrease the amount of more basic cations (e.g., Ba, Sr, Na, and/or B) present in the glass frit and/or the conductive paste composition. Notably, it may be beneficial to replace the aforementioned basic cations with less basic cations, such as Ca. Additionally, it may be advantageous to include tungsten, which may be referred to herein as “W”. Notably, W may enhance the acid resistance of a fired conductive paste composition.

In general, in some aspects, the glass frit and/or the conductive paste composition may be free of lead and/or lead oxide. In some aspects, the glass frit and/or conductive paste composition may include lead and/or lead oxide in an amount less than about 100 ppm, such as less than about 50 ppm, such as less than about 5 ppm, such as less than about 1 ppm.

In general, a glass frit (e.g., a borosilicate glass frit) may contain SiO₂ in an amount from about 20 wt. % to about 65 wt. %, including all increments of 1 wt. % therebetween. For instance, the glass frit may contain SiO₂ in an amount from about 25 wt. % to about 50 wt. %, such as from about 25 wt. % to about 45 wt. %, such as from about 30 wt. % to about 42 wt. %. Notably, an increase in the SiO₂ content of the glass frit, although it may improve the acid resistance of said frit, may increase its softening point and viscosity at the peak firing temperature of the paste, which can adversely affect the adhesion of the fired paste to the substrate.

Generally, a glass frit may contain SiO₂ in an amount from about 30 mole % to about 75 mole %, including all increments of 1 mole % therebetween. For instance, a glass frit may contain SiO₂ in an amount from about 30 mole % to about 60 mole %, such as from about 35 mole % to about 50 mole %, such as from about 40 mole % to about 50 mole %.

In some aspects, a glass frit (e.g., a borosilicate glass frit) may contain WO₃ in an amount from about 5 wt. % to about 30 wt. %, including all increments of 1 wt. % therebetween. For instance, the glass frit may contain WO₃ in an amount from about 8 wt. % to about 20 wt. %, such as from about 10 wt. % to about 20 wt. %. Notably, WO₃ may enhance the acid resistance of a conductive paste composition. For instance, the WO₃ may enhance the stability of a fired conductive paste composition and may, in effect, protect other components of the conductive paste composition from one or more acids.

Generally, a glass frit (e.g., a borosilicate glass frit) may contain WO₃ in an amount from about 1 mole % to about 10 mole %, including all increments of 1 mole % therebetween. For instance, a glass frit may contain WOs in an amount from about 2 mole % to about 8 mole %, such as from about 3 mole % to about 7 mole %.

In general, the glass frit may contain CaO in an amount from about 5 wt. % to about 35 wt. %, including all increments of 1 wt. % therebetween. For instance, the glass frit may contain CaO in an amount from about 10 wt. % to about 35 wt. %, such as from about 12 wt. % to about 30 wt. %, such as from about 12 wt. % to about 25 wt. %.

Generally, a glass frit may contain CaO in an amount from about 10 mole % to about 35 mole %, including all increments of 1 mole % therebetween. For instance, a glass frit may contain CaO in an amount from about 15 mole % to about 30 mole %, such as from about 18 mole % to about 28 mole %.

In general, the softening point of the glass frit may be from about 200° C. to about 900° C., including all increments of 1° C. therebetween. For instance, the softening point of the glass frit may be from about 200° C. to about 650° C., such as from about 450° C. to about 600° C.

In some aspects, a glass frit may have a D₅₀ particle size from about 0.1 μm to about 20 μm, including all increments of 0.1 μm therebetween. For instance, a glass frit may have a D₅₀ particle size from about 0.1 μm to about 15 μm, such as from about 0.5 μm to about 12 μm. Notably, the particle diameter (D₅₀) may be measured by laser scattering method, for example with a Microtrac model S-3500.

In some aspects, a glass frit (e.g., a borosilicate glass frit) may be present in the conductive paste composition in an amount from about 0.5 wt. % to about 10 wt. %, including all increments of 0.1 wt. % therebetween. For instance, the glass frit may be present in the conductive paste composition in an amount from about 0.5 wt. % to about 8 wt. %, such as from about 1 wt. % to about 7 wt. %, such as from about 1 wt. % to about 5 wt. %.

c. Organic Medium

The conductive paste composition of the present disclosure may include an organic medium. Notably, a metallic powder and a glass frit may be dispersed in an organic medium to form at least a portion of the conductive paste composition.

Generally, the organic medium may include one or more polymers or resins (e.g., one or more organic polymers or resins) and one or more solvents (e.g., one or more organic solvents). The one or more polymers or resins may include ethyl cellulose, ethylhydroxyethyl cellulose, wood resin, phenolic resin, polymethacrylate of a lower (CI-Q) alcohol, or a combination thereof. The one or more solvents may include aliphatic alcohols, esters of such alcohols, for example, acetates and propionates, terpenes such as terpineol, solutions of resins such as the polymethacrylates of lower alcohols, and solutions of ethyl cellulose in solvents such as Texanol, the monobutyl ether of ethylene glycol monoacetate, or a combination thereof. Generally, the one or more solvents may include Texanol (2,2,4-trimethyl-1,3-pentanediol monoisobutyrate), ester alcohol, terpineol, kerosene, dibutylphthalate, butyl carbitol, butyl carbitol acetate, dibutyl carbitol, hexylene glycol, dibasic ester, or a combination thereof. Notably, a solvent may be chosen such that the polymer(s) and/or resin(s) (e.g., organic polymer(s) and/or resin(s)) are readily soluble therein. In this respect, one or more of the polymers and/or resins of the organic medium may be soluble in one or more solvents of the organic medium.

In some aspects, a polymer or resin (e.g., an organic polymer or resin) may be present in the organic medium in an amount from about 0.1 wt. % to about 60 wt. %, including all increments of 0.1 wt. % therebetween. For instance, a polymer or resin (e.g., an organic polymer or resin) may be present in the organic medium in an amount from about 10 wt. % to about 50 wt. %, such as from about 30 wt. % to about 60 wt. %, such as from about 40 wt. % to about 55 wt. %.

In some aspects, a solvent (e.g., an organic solvent) may be present in the organic medium in an amount from about 40 wt. % to about 99.9 wt. %, including all increments of 0.1 wt. % therebetween. Generally, a solvent may be present in the organic medium in an amount from about 40 wt. % to about 70 wt. %, such as from about 40 wt. % to about 65 wt. %, such as from about 45 wt. % to about 65 wt. %, such as from about 45 wt. % to about 60 wt. %.

Notably, the organic medium may include one or more organic additives. An organic additive may be a thickener, a stabilizer, a viscosity modifier, a surfactant, a thixotrope, or a combination thereof. The amount of the organic additive(s) may depend at least partially on the desired characteristics of the resulting paste composition. Generally, an organic additive may be present in an organic medium in an amount of about 25 wt. % or less, such as about 20 wt. % or less, such as about 15 wt. % or less, such as about 10 wt. % or less, such as about 5 wt. % or less, such as about 2 wt. % or less, such as about 1 wt. % or less, such as about 0.5 wt. % or less, such as about 0.01 wt. % or more, such as about 0.1 wt. % or more. In some aspects, the sum of the weight percentages of the one or more polymers, the one or more solvents, and the one or more organic additives, may be 100 wt. %, based on the total weight of the organic medium.

In general, an organic medium may be present in a conductive paste composition in an amount from about 1 wt. % to about 25 wt. %, including all increments of 1 wt. % therebetween. Generally, an organic medium may be present in a conductive paste composition in an amount from about 1 wt. % to about 15 wt. %, such as from about 2 wt. % to about 15 wt. %, such as from about 3 wt. % to about 12 wt. %.

In general, the viscosity of a conductive paste composition can be adjusted depending on the application method of the conductive paste composition to a ceramic substrate. The viscosity of the conductive paste composition may be adjusted by altering the amount of an organic medium in the conductive paste composition, adjusting the ratio of solvent and organic polymer in the organic medium, adjusting the molecular weight of the organic polymer in the organic medium, selecting a different organic polymer for the organic medium, selecting a different solvent for the organic medium, or a combination thereof.

In general, the conductive paste composition has a suitable viscosity for application to a substrate by, for example, screen-printing, spraying, stenciling, or dipping.

d. Ruthenium-Based Powder

As previously disclosed herein, the conductive paste composition may include a ruthenium-based powder. In general, the ruthenium-based powder may include one or more of Ru, RuO₂, CaRuO₃, SrRuO₃, BaRuO₃, Li₂RuO₃, or combinations thereof. Notably, the inventors of the present disclosure have discovered that a fired conductive paste composition including ruthenium oxide (i.e., RuO₂) may have an enhanced acid resistance as compared to a fired conductive paste composition including lithium ruthenate (i.e., Li₂RuO₃).

Generally, the ruthenium-based powder (e.g., ruthenium oxide) may have an average particle size of about 10 μm or less, such as about 9 μm or less, such as about 8 μm or less, such as about 7 μm or less, such as about 6 μm or less, such as about 5 μm or less, such as about 4 μm or less, such as about 3 μm or less, such as about 2 μm or less, such as about 1 μm or less. Notably, the D₅₀ particle size of a ruthenium-based powder may be measured by laser diffraction according to the method ASTM B822-20, using water as the suspending medium and calculations based on MIE theory.

Notably, the surface area (e.g., BET surface area) of a ruthenium-based powder (e.g., ruthenium oxide) can be from about 1 to about 100 m²/g, including all increments of 1 m²/g therebetween. For instance, the surface area of a ruthenium-based powder can be from about 1 m²/g to about 50 m²/g, such as from about 5 m²/g to about 25 m²/g.

Generally, a ruthenium-based powder (e.g., ruthenium oxide) may be present in the conductive paste composition in an amount from about 0.01 wt. % to about 5 wt. %, including all increments of 0.01 wt. % therebetween. For instance, a ruthenium-based powder may be present in the conductive paste composition in an amount from about 0.01 wt. % to about 3 wt. %, such as from about 0.05 wt. % to about 3 wt. %, such as from about 0.1 wt. % to about 2 wt. %, such as from about 0.5 wt. % to about 1.5 wt. %.

e. Resistivity

Generally, the conductive paste composition of the present disclosure can have a resistivity of from about 1 mohm/sq. to about 8 mohm/sq. when fired at a temperature of less than about 950° C. In embodiments, the conductive paste can have a resistivity of from about 2 mohm/sq. to about 7 mohm/sq., such as from about 3 mohm/sq. to about 6 mohm/sq., such as from about 4 mohm/sq. to about 5 mohm/sq., when fired at a temperature of less than about 950° C. In other embodiments, the conductive paste composition can have a resistivity of from about 2 mohm/sq. to about 6 mohm/sq., such as from about 2 mohm/sq. to about 5 mohm/sq., such as from about 2.5 to about 4 mohm/sq., when fired at a temperature of about 950° C. In other embodiments, the conductive paste composition can have a resistivity of from about 2 mohm/sq. to about 6.5 mohm/sq., such as from about 3 mohm/sq. to about 6 mohm/sq., such as from about 3 mohm/sq. to about 5 mohm/sq., when fired at a temperature of about 900° C. In other embodiments, the conductive paste composition can have a resistivity of about 3 mohm/sq. to about 6 mohm/sq., such as from about 3 mohm/sq. to about 5 mohm/sq., such as from about 5.8 mohm/sq. to about 7.2 mohm/sq., when fired at a temperature of about 850° C. These resistivities may be based on a thickness of 25 microns (1 mil).

Resistivity can be measured according to the following method. Conductive paste composition is disposed in a serpentine line pattern on an alumina substrate containing 96% wt. % of Al₂O₃. The line pattern has a width of 0.5 mm and a length of 135.5 mm. The line pattern is then dried in a box oven at an appropriate temperature (e.g., 120° C. or 150° C.) for about 10 minutes. The line pattern is then fired at a peak firing temperature for 10 minutes in a furnace (e.g., a belt furnace). Notably, the entire firing process is generally longer than 10 minutes, as it may include the ramp up, the ramp down, and, optionally, a burn-out period. The average height of the line is measured with a profilometer, such as a Bruker Dektak. The resistance of the line pattern is then measured with a digital multimeter (e.g., Model 2100, Keithley Instruments, Inc). It should be understood that from the number of squares that make up the serpentine, the measured average height of the line, and the measured resistance, the resistivity in ohms/sq. for a given thickness may be calculated.

f. Acid Resistance

Notably, the conductive paste composition of the present disclosure is acid resistant. As used herein, “acid resistant” refers to passing an acid resistance test whereby 2×2 mm squares of conductive paste composition are printed onto an aluminum nitride substrate. Each square or pad has a width of 2 mm, a length of 2 mm, and a fired thickness of 30 μm. The squares are then dried at a temperature of 120° C. for 10 minutes in a box oven. The squares are fired at a peak firing temperature of 850° C. to 950° C. for 10 minutes in a belt furnace. After firing, the substrate is submersed for 5 minutes in a 5 wt. % sulfuric acid solution held at 30° C. The bath is stirred during this time. The substrate is rinsed with deionized water and allowed to dry.

To assess the strength of the bond between the conductive square or pad and the substrate after the immersion in sulfuric acid, a tinned 20 gauge copper wire is soldered to the pad and pulled perpendicular to the plane of the substrate. Notably, after soldering, the wire may be bent upwards, perpendicular to the substrate, with a very slight curve at the base, before being pulled by the pull tester. A conductive paste composition is considered “acid resistant” if the average wire-pull adhesion is at least 15 N. It should be understood that the Test Methods disclosure of the Examples discloses a method of determining the acid resistance of a conductive paste composition via the Acid Resistance Test.

g. Method of Forming the Conductive Paste Composition

In some aspects, a conductive paste composition formed in accordance with the present disclosure may be formed by dispersing the metallic powder, the glass frit, the organic medium, the ruthenium-based powder, and one or more other components, such as any of the components disclosed herein, in a mechanical mixer, such as a Dispersator or PowerMix, or a centrifugal mixer, such as a Thinky mixer, or an acoustic mixer, such as those made by Resodyne, and homogenizing the mixture. Notably, the mixture may be further homogenized with a three-roll mill (such as those made by Ross) to achieve good dispersion of the particles. A Hegman gauge may be used to determine the state of dispersion of the particles in the conductive paste composition. This instrument may include a channel in a block of steel that is 25 microns deep (1 mil) on one end and ramps up to zero depth at the other end. A blade may be used to draw down paste along the length of the channel. Scratches will appear in the channel where the agglomerates' diameter is greater than the channel depth. A satisfactory dispersion will generally give a fourth scratch point of 10-18 microns. The point at which half of the channel is uncovered with a well dispersed paste is generally between 2 and 8 microns. Notably, a fourth scratch measurement of >20 microns and “half-channel” measurements of >10 microns indicate a poorly dispersed suspension.

### II. Articles

The conductive paste composition can be applied to a substrate and fired forming an article including a substrate and a fired conductive paste composition, which may be a conductive layer, present thereon. Notably, the conductive paste composition can be utilized in a wide array of applications (e.g., batteries, solar cells and panels, sensors, electronics, etc.) where high conductivity and/or high adhesion is desirable. For instance, the conductive paste composition of the present disclosure can be fired at temperatures under 950° C., while maintaining excellent adhesion and acid resistant properties as described in the Examples provided hereinbelow.

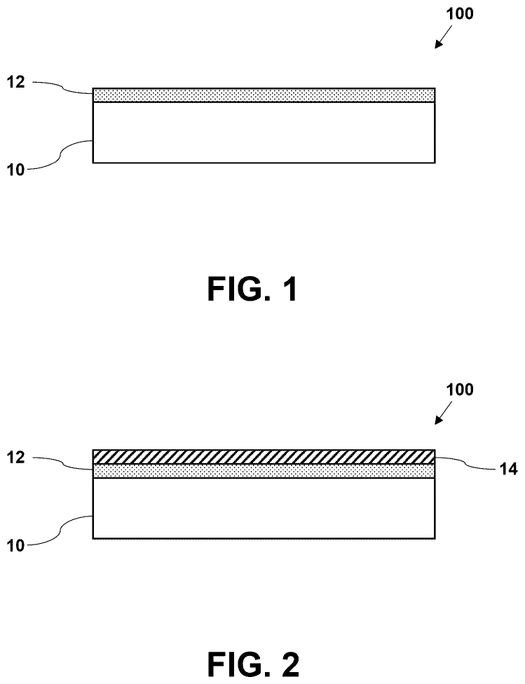

Referring now to FIG. 1, FIG. 1 illustrates one aspect of an article 100 formed in accordance with the present disclosure. FIG. 1 illustrates an article 100 including a substrate 10 (e.g., an aluminum nitride substrate) having a fired conductive paste composition 12 present thereon. Notably, prior to firing, the conductive paste composition may include a metallic powder, a glass frit, an organic medium, a ruthenium-based powder, or a combination thereof.

As previously disclosed herein, a conductive paste composition formed in accordance with the present disclosure may include one or more metallic powders. Notably, the one or more metallic powders may include aluminum, copper, gold, nickel, palladium, platinum, silver, or a combination or alloy thereof.

In some aspects, the metallic powder may be present in the conductive paste composition in an amount from about 30 wt. % to about 95 wt. %, including all increments of 1 wt. % therebetween. For instance, the metallic powder may be present in the conductive paste composition in an amount from about 50 wt. % to about 90 wt. %, such as from about 60 wt. % to about 90 wt. %, such as from about 70 wt. % to about 85 wt. %.

In general, a metallic powder formed in accordance with the present disclosure may include from about 90 wt. % to about 100 wt. % of an elemental metal (e.g., copper), including all increments of 0.01 wt. % therebetween. For instance, the metallic powder may include an elemental metal in an amount from about 92 wt. % to about 100 wt. %, such as from about 95 wt. % to about 100 wt. %, such as from about 98 wt. % to about 100 wt. %.

In some aspects, the metallic powder may be a copper powder. Notably, a copper powder may include copper oxide. Copper oxide may improve the adhesion of a fired conductive paste composition on ceramic substrates (e.g., aluminum nitride substrates), so when considering the copper oxide content of a conductive paste composition, it is important to note the contribution from the copper oxide of the copper powder.

In some aspects, the conductive paste composition may include copper oxide, such as Cu₂O and/or CuO, in an amount from about 0.001 wt. % to about 20 wt. %, including all increments of 1 wt. % therebetween. For instance, the conductive paste composition may include copper oxide, such as Cu₂O and/or CuO, in an amount from about 0.1 wt. % to about 15 wt. %, such as from about 1 wt. % to about 12 wt. %, such as from about 2 wt. % to about 10 wt. %. In some aspects, the copper oxide may be a milled copper oxide.

As previously disclosed herein, a conductive paste composition formed in accordance with the present disclosure may include a glass frit.

A glass frit may include one or more oxides, one or more halides, one or more carbonates, one or more nitrates, one or more phosphates, one or more hydroxides, one or more peroxides, one or more halogen compounds, or a combination thereof. In some aspects, the glass frit may include one or more metal oxides. For instance, a glass frit may include aluminum oxides (e.g., Al₂O₃), boron oxides (e.g., B₂O₃), calcium oxides (e.g., CaO), copper oxides (e.g., CuO, Cu₂O), lithium oxides (e.g., Li₂O), manganese oxides (e.g., MnO₂), silicon oxides (e.g., SiO₂), sodium oxides (e.g., Na₂O), tungsten oxides (e.g., WO₃), zirconium oxides (e.g., ZrO₂), or a combination thereof. A glass frit formed in accordance with the present disclosure may be substantially free of zinc oxides (e.g., ZnO), barium oxides (e.g., BaO), bismuth oxides (e.g., Bi₂O₃), strontium oxides (e.g., SrO), or a combination thereof. It should be understood that the conductive paste composition may be substantially free of zinc oxides, barium oxides, bismuth oxides, strontium oxides, or a combination thereof.

In general, a glass frit may contain SiO₂ in an amount from about 20 wt. % to about 65 wt. %, including all increments of 1 wt. % therebetween. For instance, the glass frit may contain SiO₂ in an amount from about 25 wt. % to about 50 wt. %, such as from about 25 wt. % to about 45 wt. %, such as from about 30 wt. % to about 42 wt. %. Notably, an increase in the SiO₂ content of the glass frit may increase its softening point as well as its viscosity at the peak firing temperature. Too high a softening point can lead to poor adhesion, as the glass doesn't flow sufficiently during the firing process.

Generally, a glass frit may contain SiO₂ in an amount from about 30 mole % to about 75 mole %, including all increments of 1 mole % therebetween. For instance, a glass frit may contain SiO₂ in an amount from about 30 mole % to about 60 mole %, such as from about 35 mole % to about 50 mole %, such as from about 40 mole % to about 50 mole %.

In some aspects, a glass frit may contain WO₃ in an amount from about 5 wt. % to about 30 wt. %, including all increments of 1 wt. % therebetween. For instance, the glass frit may contain WOs in an amount from about 8 wt. % to about 20 wt. %, such as from about 10 wt. % to about 20 wt. %. Notably, WO₃ may enhance the acid resistance of a conductive paste composition. For instance, the WO₃ may enhance the stability of a fired conductive paste composition and may, in effect, protect other components of the conductive paste composition from one or more acids.

Generally, a glass frit may contain WO₃ in an amount from about 1 mole % to about 10 mole %, including all increments of 1 mole % therebetween. For instance, a glass frit may contain WO₃ in an amount from about 2 mole % to about 8 mole %, such as from about 3 mole % to about 7 mole %.

In general, the glass frit may contain CaO in an amount from about 5 wt. % to about 35 wt. %, including all increments of 1 wt. % therebetween. For instance, the glass frit may contain CaO in an amount from about 10 wt. % to about 35 wt. %, such as from about 12 wt. % to about 30 wt. %, such as from about 12 wt. % to about 25 wt. %.

Generally, a glass frit may contain CaO in an amount from about 10 mole % to about 35 mole %, including all increments of 1 mole % therebetween. For instance, a glass frit may contain CaO in an amount from about 15 mole % to about 30 mole %, such as from about 18 mole % to about 28 mole %.

In some aspects, a glass frit may be present in the conductive paste composition in an amount from about 0.5 wt. % to about 10 wt. %, including all increments of 0.1 wt. % therebetween. For instance, the glass frit may be present in the conductive paste composition in an amount from about 0.5 wt. % to about 8 wt. %, such as from about 1 wt. % to about 7 wt. %, such as from about 1 wt. % to about 5 wt. %.

The conductive paste composition of the present disclosure may include an organic medium. Notably, a metallic powder and a glass frit may be dispersed in an organic medium to form at least a portion of the conductive paste composition.

Generally, the organic medium may include one or more polymers (e.g., one or more organic polymers) and one or more solvents (e.g., one or more organic solvents). The one or more polymers may include ethyl cellulose, ethylhydroxyethyl cellulose, wood resin, phenolic resin, polymethacrylate of a lower (CI-Q) alcohol, or a combination thereof. The one or more solvents may include aliphatic alcohols, esters of such alcohols, for example, acetates and propionates, terpenes such as terpineol, solutions of resins such as the polymethacrylates of lower alcohols, and solutions of ethyl cellulose in solvents such as Texanol, the monobutyl ether of ethylene glycol monoacetate, or a combination thereof. Generally, the one or more solvents may include Texanol (2,2,4-trimethyl-1,3-pentanediol monoisobutyrate), ester alcohol, terpineol, kerosene, dibutylphthalate, butyl carbitol, butyl carbitol acetate, dibutyl carbitol, hexylene glycol, dibasic ester, or a combination thereof. Notably, a solvent may be chosen such that the polymer(s) (e.g., organic polymer(s)) are readily soluble therein. In this respect, one or more of the polymers of the organic medium may be soluble in one or more solvents of the organic medium.

In some aspects, a polymer (e.g., an organic polymer) may be present in the organic medium in an amount from about 0.1 wt. % to about 60 wt. %, including all increments of 0.1 wt. % therebetween. For instance, a polymer (e.g., an organic polymer) may be present in the organic medium in an amount from about 5 wt. % to about 50 wt. %, such as from about 10 wt. % to about 40 wt. %, such as from about 15 wt. % to about 30 wt. %.

In some aspects, a solvent (e.g., an organic solvent) may be present in the organic medium in an amount from about 40 wt. % to about 99.9 wt. %, including all increments of 0.1 wt. % therebetween. Generally, a solvent may be present in the organic medium in an amount from about 50 wt. % to about 95 wt. %, such as from about 60 wt. % to about 90 wt. %, such as from about 65 wt. % to about 85 wt. %, such as from about 70 wt. % to about 85 wt. %.

In general, an organic medium may be present in a conductive paste composition in an amount from about 1 wt. % to about 25 wt. %, including all increments of 1 wt. % therebetween. Generally, an organic medium may be present in a conductive paste composition in an amount from about 1 wt. % to about 15 wt. %, such as from about 2 wt. % to about 15 wt. %, such as from about 3 wt. % to about 12 wt. %.

As previously disclosed herein, the conductive paste composition may include a ruthenium-based powder. In general, the ruthenium-based powder may include one or more of Ru, RuO₂, CaRuO₃, SrRuO₃, BaRuO₃, Li₂RuO₃, or combinations thereof. Notably, the inventors of the present disclosure have discovered that a fired conductive paste composition including ruthenium oxide (i.e., RuO₂) may have an enhanced acid resistance as compared to a fired conductive paste composition including lithium ruthenate (i.e., Li₂RuO₃).

Generally, a ruthenium-based powder (e.g., ruthenium oxide) may be present in the conductive paste composition in an amount from about 0.01 wt. % to about 5 wt. %, including all increments of 0.01 wt. % therebetween. For instance, a ruthenium-based powder (e.g., ruthenium oxide) may be present in the conductive paste composition in an amount from about 0.01 wt. % to about 3 wt. %, such as from about 0.05 wt. % to about 3 wt. %, such as from about 0.1 wt. % to about 2 wt. %, such as from about 0.5 wt. % to about 1.5 wt. %.

Referring now to FIG. 2, FIG. 2 illustrates one aspect of an article 100 formed in accordance with the present disclosure. FIG. 2 illustrates an article 100 including a substrate 10 (e.g., a ceramic substrate) having a fired conductive paste composition 12 present thereon. Further, as illustrated in FIG. 2, the fired conductive paste composition 12 has a metal layer 14 (e.g., plated metal layer) present thereon.

In general, the metal layer may be formed from plating a plating composition on a substrate. The metal layer may include a metal, such as aluminum, copper, gold, nickel, palladium, platinum, silver, or a combination or alloy thereof. Notably, the plating composition may include metal ions, such as aluminum ions, copper ions, gold ions, nickel ions, palladium ions, platinum ions, silver ions, or a combination thereof. Generally, plating (e.g., electrolytic plating, electroless plating) a metal layer to a substrate and/or a fired conductive paste composition may involve subjecting the ceramic substrate and/or the fired conductive paste composition to an acidic environment, which may be an acidic solution or acidic bath.

### III. Methods

The present disclosure also provides a method of manufacturing an article including a ceramic substrate and a fired conductive paste composition, including the steps of preparing a ceramic substrate, applying a conductive paste composition on the ceramic substrate, and firing the ceramic substrate with the applied conductive paste composition.

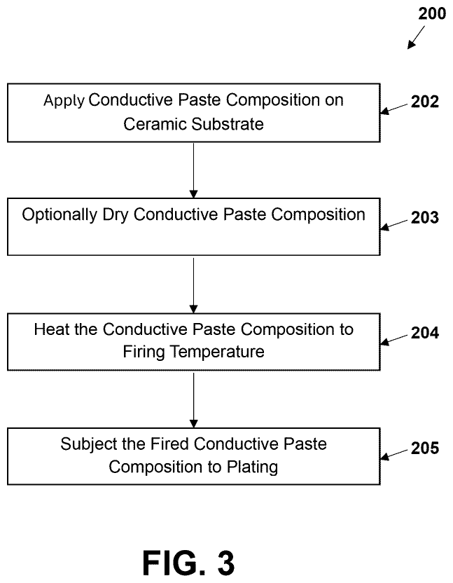

Referring now to FIG. 3, FIG. 3 illustrates a flow diagram of one example method (200) of forming an article according to the present disclosure. At (202) the method includes applying a conductive paste composition to a ceramic substrate. In general, the conductive paste composition may be applied by screen-printing, spraying, or dipping. With respect to screen-printing, the conductive paste composition may be printed onto a substrate via an automatic printer or a hand printer, using a 400 to 165 mesh screen, including all incremental values therebetween.

In general, a conductive paste composition may be applied to at least a portion of the surface of a ceramic substrate, such as the entire surface of the ceramic substrate. Generally, a conductive paste composition may be applied to and/or be present on the surface of a ceramic substrate in an amount from about 1% to about 100% of the surface of the ceramic substrate, including all increments of 1% therebetween. In some aspects, a fired conductive paste composition may be present on the surface of a ceramic substrate in an amount from about 1% to about 100% of the surface area of the surface of the ceramic substrate, including all increments of 1% therebetween.

Generally, a conductive paste composition may be applied to and/or be present on one or more faces (e.g., first face, second face) of a ceramic substrate in an amount from about 1% to about 100% of the surface of the face of the ceramic substrate, including all increments of 1% therebetween. In some aspects, a fired conductive paste composition may be present on one or more faces (e.g., first face, second face) of a ceramic substrate in an amount from about 1% to about 100% of the surface area of the surface of the face of the ceramic substrate, including all increments of 1% therebetween. A face may be a major surface of the ceramic substrate.

In general, a ceramic substrate may include aluminum, barium, beryllium, calcium, lanthanum, magnesium, manganese, niobium, neodymium, nickel, lead, samarium, tin, strontium, tantalum, tungsten, zinc, zirconium, or a combination thereof. Notably, a ceramic substrate may include one or more of the aforementioned metals in an amount of about 60 mole % or more, such as about 70 mole % or more, such as about 80 mole % or more, such as about 90 mole % or more, such as about 95 mole % or more.

In some aspects, a ceramic substrate may include an oxide (e.g., a metal oxide). For instance, a ceramic substrate may include aluminum oxide, barium oxide, beryllium oxide, calcium oxide, lanthanum oxide, magnesium oxide, manganese oxide, niobium oxide, neodymium oxide, nickel oxide, lead oxide, samarium oxide, tin oxide, strontium oxide, tantalum oxide, tungsten oxide, zinc oxide, zirconium oxide, or a combination thereof. In some aspects, a ceramic substrate may include a nitride (e.g., a metal nitride). For instance, a ceramic substrate may include aluminum nitride, barium nitride, calcium nitride, lanthanum nitride, magnesium nitride, manganese nitride, niobium nitride, neodymium nitride, nickel nitride, samarium nitride, strontium nitride, tantalum nitride, tungsten nitride, zinc nitride, zirconium nitride, or a combination thereof.

In some aspects, a ceramic substrate may include Al₂O₃, AlN, BaTi₄O₉, Ba₂Ti₉O₂₀, BaSnO₃, BaMgO₃, BaTaO₃, BaZrO₃, Ba(ZrTi)O₃, Ba(NiTa)O₃, Ba(ZrZnTa)O₃, Ba(Mg_{1/3}Ta_{2/3})O₃, Ba(Mg_{1/3}Nb_{2/3})O₃, Ba(Zn_{1/3}Ta_{2/3})O₃, Ba(Zn_{1/3}Nb_{2/3})O₃, Ba(Mn_{1/3}Ta_{2/3})O₃, BeO, CaTiO₃, (CaSrBa)ZrO₃, MgTiO₃, (Mg_{0.95}Ca_{0.05})TiO₃, SiC, SrZrO₃, Sr(Zn_{1/3}Nb_{2/3})O₃, Sr(Zn_{1/3}Ta_{2/3})O₃, ZrTiO₂, (Zr_{0.8}Sn_{0.2})TiO₄, or a combination thereof.

Generally, a ceramic substrate may be surface treated. For instance, the ceramic substrate may be smoothed or roughened. In some aspects, the ceramic substrate may have a primer layer applied thereon. A primer layer may be formed by chemical vapor deposition or by plating.

As illustrated at (203) of FIG. 3, the conductive paste composition may be optionally dried after the application of the conductive paste composition to the ceramic substrate and before the firing step. In general, the conductive paste composition may be dried at a temperature from about 50° C. to about 250° C., including all increments of 1° C. therebetween. The conductive paste composition may be dried for a period of time from about 3 minutes to about 30 minutes, including all increments of 1 minute therebetween. Notably, firing without drying may lead to blistering or the formation of voids. The drying process may take place under an oxidizing atmosphere (e.g., air) or an inert atmosphere (e.g., nitrogen). Generally, if the drying process takes place in an oxidizing atmosphere, the temperature may be minimized to avoid excess oxidation of copper particles present in the paste. In general, if the drying takes place in air, temperatures at or less than 120° C. may be preferable.

As illustrated at (204) of FIG. 3, the ceramic substrate and the conductive paste composition may be heated to firing temperature. The firing may be carried out under an oxidizing atmosphere (e.g., air) or an inert atmosphere (e.g., nitrogen). The firing may be carried out under oxygen-poor conditions, for example, in a nitrogen atmosphere or argon atmosphere, or under vacuum. Generally, the firing may be carried out at atmospheric pressure. In general, the ceramic substrate with the applied conductive paste composition is fired to sinter the conductive paste composition on the ceramic substrate. Notably, the firing of the conductive paste composition may volatize components of the organic medium and may sinter the metallic powder, the glass frit, the ruthenium-based powder, and/or any other component of the conductive paste composition disclosed herein. During the firing process, the glass frit may soften gradually with increasing temperature and may eventually flow. The glass frit may aid to sinter the metallic powder (e.g., copper powder) during the process, so that an electrically conductive layer is formed. Furthermore, a melted glass formed from the glass frit may react with the ceramic substrate resulting in a glass layer being formed between the ceramic substrate and a metal rich upper layer of the fired conductive paste composition.

In general, the firing peak temperature may be from about 600° C. to about 1100° C., including all increments of 1° C. therebetween. For instance, the firing peak temperature may be from about 650° C. to about 1050° C., such as from about 800° C. to about 1000° C., such as from about 850° C. to about 950° C.

The firing of the ceramic substrate and the conductive paste composition may occur for a period of time from about 3 minutes to about 30 minutes, including all increments of 1 minute therebetween.

Notably, the fired conductive paste composition may have a thickness from about 5 μm to about 50 μm, including all increments of 1 μm therebetween. For instance, the fired conductive paste composition may have a thickness from about 5 μm to about 50 μm, such as from about 10 μm to about 40 μm, such as from about 15 μm to about 30 μm.

As illustrated at (205) of FIG. 3, the ceramic substrate and/or the fired conductive paste composition of the article, including the ceramic substrate and the fired conductive paste composition, may undergo or be subjected to plating. In this respect, the ceramic substrate and/or the fired conductive paste composition may have a plating composition deposited thereon. Notably, the ceramic substrate and/or the fired conductive paste composition may have a plating composition deposited thereon to form a metal layer, which may be referred to as a plated metal layer. A plated ceramic substrate and/or a plated fired conductive paste composition may be formed. In general, the plating composition may include a metal, such as aluminum, copper, gold, nickel, palladium, platinum, silver, or a combination or alloy thereof. Notably, the plating composition may include metal ions, such as aluminum ions, copper ions, gold ions, nickel ions, palladium ions, platinum ions, silver ions, or a combination thereof. In some aspects, the ceramic substrate and/or the fired conductive paste composition may be subjected to electrolytic plating and/or electroless plating.

Notably, plating (e.g., electrolytic plating, electroless plating) may involve subjecting the ceramic substrate and/or the fired conductive paste composition to an acidic environment, which may be an acidic solution or acidic bath. The inventors of the present disclosure have discovered that a fired conductive paste composition formed in accordance with the present disclosure maintains adhesion to the ceramic substrate during and after the fired conductive paste composition is subjected to an acidic solution or environment, which is particularly advantageous for processes involving plating.

In general, for electrolytic plating, a ceramic substrate having a fired conductive paste composition present thereon may be immersed or submerged in an electrolyte solution in a container. The electrolyte solution may be acidic. For instance, the electrolyte solution may have a pH of about 6.5 or less, such as about 6 or less, such as about 5.5 or less, such as about 5 or less, such as about 4.5 or less, such as about 4 or less, such as about 1 or more. In general, the container may contain a plating composition (e.g., nickel) and/or ions thereof. For instance, the container may contain an anode of the plating composition intended to be plated or deposited on the ceramic substrate and/or on the fired conductive paste composition present on the ceramic substrate. Notably, the ceramic substrate and/or fired conductive paste composition may act as a cathode. After being immersed or submerged in the electrolyte solution, an electric current may be applied to the electrolyte solution via a power source. While the electric current is being applied, ions of the plating composition (e.g., nickel ions) may be deposited onto the surface of the ceramic substrate and/or the fired conductive paste composition. The resulting article may include the ceramic substrate and/or the fired conductive paste composition having one or more metal ions (e.g., aluminum ions, copper ions, gold ions, nickel ions, palladium ions, platinum ions, silver ions) present or deposited thereon. For instance, the resulting article may include a metal layer formed by the plating process. Notably, the metal layer may be formed from the plating composition.

Generally, for electroless plating, a ceramic substrate having a fired conductive paste composition present thereon may be immersed or submerged in a solution in a container. The solution may be acidic. For instance, the solution may have a pH of about 6.5 or less, such as about 6 or less, such as about 5.5 or less, such as about 5 or less, such as about 4.5 or less, such as about 4 or less, such as about 1 or more. In general, the container may contain a plating composition (e.g., nickel) and/or ions thereof. For instance, the container may contain nickel ions intended to be plated or deposited on the ceramic substrate and/or on the fired conductive paste composition present on the ceramic substrate. The solution may also contain a reducing agent. For instance, the solution may include one or more reducing agents, such as sodium hypophosphite, sodium borohydride, dimethylamine borane, hydrazine, formaldehyde, or a combination thereof. After the ceramic substrate having a fired conductive paste composition thereon is immersed or submerged in the solution, the reducing agent may chemically reduce the plating composition and/or ions thereof such that ions of the plating composition (e.g., nickel ions) may be deposited onto the surface of the ceramic substrate and/or fired conductive paste composition. The resulting article may include the ceramic substrate and/or the fired conductive paste composition having one or more metal ions (e.g., aluminum ions, copper ions, gold ions, nickel ions, palladium ions, platinum ions, silver ions) present or deposited thereon. For instance, the resulting article may include a metal layer formed by the plating process. Notably, the metal layer may be formed from the plating composition.

### Test Methods

Acid Resistance Test: The acid resistance test was performed by immersing a ceramic substrate having a fired conductive paste composition present thereon in a 5 wt. % sulfuric acid bath at 30° C. for 5 minutes. The bath was stirred during the test. As used herein, the fired conductive paste composition may be referred to as a pad. Next, the ceramic substrate having a fired conductive paste composition present thereon was removed from the sulfuric acid bath, rinsed with deionized water, and allowed to dry. Then, the adhesion of the fired conductive paste composition was measured. Notably, adhesion was measured using an Instron Model 1122 pull tester in a 90° peel configuration at a pull rate of 2 inches per minute. To measure the adhesion, a 20-gauge pre-tinned copper wire was attached to an 80 mil×80 mil pad of the fired conductive paste composition by dipping in 96.5Sn/3.0Ag/0.5Cu solder held at 245° C. for 10 seconds after applying Alpha 611 flux. The wire, prior to soldering, was lying flat directly on top of the pad. After soldering, the wire was bent upwards, perpendicular to the substrate, with a very slight curve at the base, before being pulled by the pull tester. For each respective example, at least 15 pads were subjected to the acid resistance test. The acid resistance test is considered a “pass” if the average peel force required to separate the fired conductive paste composition from the ceramic substrate was 15 N or more.

### Examples

The present disclosure is further illustrated by, but is not limited to, the following examples.

Conductive paste compositions were prepared by dispersing and mixing various combinations of a copper powder, a glass frit, a ruthenium-based powder, copper oxide, ethyl cellulose, Texanol, polyoxyethylene (4) lauryl ether, dibutyl sebacate, Disperbyk-2155 TF, and butyl carbitol acetate in a mixer. Each conductive paste composition was roll milled and adjusted as needed to around 150-200 Pa's viscosity at 10 rpm by thinning with additional Texanol (Brookfield HAT, #14 spindle, #6R small sample adaptor for viscosity testing). Each conductive paste composition was printed onto 1″×1″×0.025″ AlN substrates (Saint-Gobain, 170 W/m-K). Each conductive paste composition was then dried at 120° C. for 10 minutes in air, and fired in a belt furnace in a nitrogen atmosphere at 900° C. peak temperature for 10 minutes. The door-to-door time through the belt furnace was approximately 1 hour. The fired thickness of each fired conductive paste composition was approximately 30 microns. The resistivity was measured as described above and was 1.2 milliohms/square normalized to 30 microns fired thickness. Each example was subjected to the acid resistance test.

The composition of each glass frit used in each conductive paste composition is illustrated in Table 1. The composition of each conductive paste composition is illustrated in Table 2.

TABLE 1

| | Glass | Glass | Glass | Glass | Glass | Glass |
|---|---|---|---|---|---|---|
| | Frit A | Frit B | Frit C | Frit D | Frit E | Frit F |
| Component | [wt. %] | [wt. %] | [wt. %] | [wt. %] | [wt. %] | [wt. %] |
| SiO₂ | 20.2291 | 34.3958 | 52.3838 | 37.1728 | 37.0276 | 36.6510 |
| Al₂O₃ | 2.8023 | 2.5015 | 3.5558 | 3.6046 | 3.5906 | 3.4553 |
| B₂O₃ | 20.3950 | 14.2338 | 15.1744 | 15.3830 | 15.3229 | 13.5661 |
| Na₂O | 3.3294 | 1.0137 | 1.0807 | 1.0956 | 1.0913 | 1.0502 |
| CuO | — | 3.9031 | 2.7740 | 4.2182 | — | — |
| WO₃ | — | 15.1677 | 16.1700 | 16.3923 | 16.3283 | 19.6416 |
| Li₂O | — | 1.9550 | 1.8236 | 2.1128 | 2.1045 | 2.0253 |
| SrO | 13.7216 | 16.1005 | — | — | — | — |
| CaO | — | 8.7134 | 4.8890 | 17.8425 | 17.7729 | 17.1034 |
| ZrO₂ | — | 2.0154 | 2.1486 | 2.1781 | 2.1696 | 2.0879 |
| MnO₂ | — | — | — | — | 4.5922 | 4.4192 |
| MgO | 3.1218 | — | — | — | — | — |
| TiO₂ | 5.4885 | — | — | — | — | — |
| ZnO | 10.0661 | — | — | — | — | — |
| BaO | 18.9635 | — | — | — | — | — |
| SnO₂ | 1.8828 | — | — | — | — | — |

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| Frit Type | A | B | B | C | D | E | E | E | F | D |
| Type of Ruthenium-Based | Li₂RuO₃ | Li₂RuO₃ | RuO₂ | RuO₂ | Li₂RuO₃ | — | RuO₂ | RuO₂ | RuO₂ | RuO₂ |
| Powder Added | | | | | | | | | | |
| Type of Copper Oxide Added | Cu₂O | Cu₂O | Cu₂O | Cu₂O | Cu₂O | Cu₂O | Cu₂O | Cu₂O | Cu₂O | Cu₂O |
| Copper Powder [wt. %] | 80.3614 | 80.2681 | 80.2681 | 80.6490 | 80.2681 | 81.1000 | 81.0445 | 80.5992 | 80.1000 | 80.2681 |
| Glass Frit | 2.9772 | 2.9729 | 2.9729 | 3.0019 | 2.9729 | 3.0000 | 3.0017 | 3.0000 | 3.0000 | 2.9729 |
| [wt. %] | | | | | | | | | | |
| Copper Oxide | 5.9532 | 5.9458 | 5.9458 | 5.3485 | 5.9458 | 6.0000 | 6.0033 | 6.0000 | 6.0000 | 5.9458 |
| [wt. %] | | | | | | | | | | |
| Ruthenium-Based Powder | 0.9433 | 0.9414 | 0.9414 | 1.0006 | 0.9414 | | 0.9505 | 0.9453 | 1.000 | 0.9414 |
| [wt. %] | | | | | | | | | | |
| Ethyl Cellulose | 0.4324 | 0.4163 | 0.4163 | 0.4183 | 0.4163 | 0.4237 | 0.3152 | 0.3637 | 0.4237 | 0.4163 |
| [wt. %] | | | | | | | | | | |
| Dibutyl sebacafe | 2.7026 | 2.6018 | 2.6018 | 2.6141 | 2.6018 | 2.6481 | 1.9702 | 1.5029 | 2.6481 | 2.6018 |
| [wt. %] | | | | | | | | | | |
| Polyoxyethylene (4) | — | 0.9959 | 0.9959 | 1.0006 | 0.9959 | 1.0000 | 0.9552 | 0.9500 | 1.0000 | 0.9959 |
| lauryl ether [wt.%] | | | | | | | | | | |
| Texanol | 3.4987 | 5.8578 | 5.8578 | 5.9670 | 5.8578 | 5.8282 | 5.7594 | 6.6389 | 5.8282 | 5.8578 |
| [wt. %] | | | | | | | | | | |
| Disperbyk-2155 TF | 0.8940 | — | — | — | — | — | — | — | — | — |
| [wt. %] | | | | | | | | | | |
| Butyl carbitol acetate | 2.2372 | — | — | — | — | — | — | — | — | — |
| [wt. %] | | | | | | | | | | |
| Acid Resistance Test | <15N | <15N | <15N | <15N | <15N | <15N | Pass | Pass | Pass | Pass |

As illustrated in Tables 1 and 2, Example 5 and Example 10 have the same composition except for the use of Li₂RuO₃ and RuO₂ in Example 5 and Example 10, respectively. Notably, Example 5 delaminated when tested in accordance with the acid resistance test whereas Example 10 passed the acid resistance test and did not delaminate.

As illustrated in Table 2, Example 7 and Example 8 include ruthenium oxide while Example 6 excludes ruthenium oxide. Notably, Example 6 showed suboptimal adhesion to the substrate before being subjected to the acid resistance test. Example 6 delaminated when tested in accordance with the acid resistance test whereas Examples 7 and 8 passed the acid resistance test and did not delaminate.

As illustrated in Tables 1 and 2, Example 4 includes a glass frit C having an increased silicon dioxide content and a decreased calcium oxide content as compared to the glass frits of Examples 5-6 and Examples 7-10. Although glass frit C generally exhibits good acid resistance, Example 4 showed suboptimal adhesion to the substrate even before being subjected to the acid resistance test. Notably, the higher silicon dioxide content of frit C made it “harder,” meaning it did not soften and flow sufficiently at the firing temperature of the paste, and thus provided poor adhesion to the substrate.

As illustrated in Tables 1 and 2, Example 3 includes a glass frit B containing strontium oxide, while Example 10 replaces the strontium oxide with the calcium oxide of glass frit D. Notably, calcium oxide exhibits lower basicity than strontium oxide, particularly in terms of its interaction with acids. Example 3 failed the acid adhesion test, whereas Example 10 passed the test. In this respect, Example 3 and Example 10 demonstrate that replacing a more basic cation with a less basic cation may advantageously improve acid resistance.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A conductive paste composition comprising:
a metallic powder;
a borosilicate glass frit, the borosilicate glass frit comprising SiO₂, B₂O₃, and WO₃;
a ruthenium-based powder; and
an organic medium, the organic medium comprising a solvent and a polymer or resin.

2. The conductive paste composition of claim 1, wherein the metallic powder comprises a copper powder.

3. The conductive paste composition of claim 1, wherein the metallic powder is present in the conductive paste composition in an amount of about 50 wt. % to about 95 wt. %.

4. The conductive paste composition of claim 1, wherein the conductive paste composition further comprises copper oxide, the copper oxide being present in the conductive paste composition from about 0.1 wt. % to about 15 wt. %.

5. The conductive paste composition of claim 1, wherein the glass frit is present in the conductive paste composition in an amount from about 0.5 wt. % to about 10 wt. %.

6. The conductive paste composition of claim 1, wherein the glass frit comprises WO₃ in an amount from about 5 wt. % to about 30 wt. %, based on the total weight of the glass frit.

7. The conductive paste composition of claim 1, wherein the glass frit comprises WO₃ in an amount from about 8 wt. % to about 20 wt. %, based on the total weight of the glass frit.

8. The conductive paste composition of claim 1, wherein the glass frit further comprises CaO in an amount from about 5 wt. % to about 35 wt. %, based on the total weight of the glass frit.

9. The conductive paste composition of claim 1, wherein the glass frit further comprises CaO in an amount from about 12 wt. % to about 30 wt. %, based on the total weight of the glass frit.

10. The conductive paste composition of claim 1, wherein the ruthenium-based powder is ruthenium oxide, the ruthenium oxide being present in the conductive paste composition in an amount from about 0.5 wt. % to about 5 wt. %.

11. The conductive paste composition of claim 1, wherein the organic medium is present in the conductive paste composition in an amount from about 3 wt. % to about 20 wt. %.

12. The conductive paste composition of claim 1, wherein the glass frit is substantially free of zinc oxide.

13. The conductive paste composition of claim 1, wherein the glass frit is substantially free of strontium oxide.

14. The conductive paste composition of claim 1, wherein the glass frit is substantially free of barium oxide.

15. An article comprising:
a ceramic substrate; and
a fired conductive paste composition; the fired conductive paste composition being formed from a conductive paste composition, the conductive paste composition comprising:
a metallic powder;
a borosilicate glass frit, the borosilicate glass frit comprising SiO₂, B₂O₃, and WO₃;
a ruthenium-based powder; and
an organic medium, the organic medium comprising a solvent and a polymer or resin.

16. The article of claim 15, wherein the ceramic substrate comprises aluminum nitride.

17. The article of claim 15, wherein the glass frit is present in the conductive paste composition in an amount from about 0.5 wt. % to about 10 wt. %.

18. The article of claim 15, wherein the glass frit comprises WO₃ in an amount from about 8 wt. % to about 20 wt. % based on the total weight of the glass frit, wherein the glass frit further comprises CaO, wherein the glass frit comprises CaO in an amount from about 12 wt. % to about 30 wt. % based on the total weight of the glass frit.

19. A process for forming an article comprising:
applying a conductive paste composition to a ceramic substrate, the conductive paste composition comprising:
a metallic powder;
a borosilicate glass frit, the borosilicate glass frit comprising SiO₂, B₂O₃, and WO₃;
a ruthenium-based powder;
an organic medium, the organic medium comprising a solvent and a polymer or resin; and
firing the conductive paste composition such that the conductive paste composition forms a fired conductive paste composition on the ceramic substrate.

20. The process for forming an article of claim 19, wherein the glass frit comprises WO₃ in an amount from about 8 wt. % to about 20 wt. %.
